(19) United States
(12) Patent Application Publication
(10) Pub. No.: US 2013/0165603 A1
(43) Pub. Date: Jun. 27, 2013

(54) Adhesive Composition And Adhesive Film Comprising The Same

(71) Applicants: Kyoung Tae WI, Uiwang-si (KR); Sang Jin KIM, Uiwang-si (KR); Cheol Su KIM, Uiwang-si (KR); Seung Yong YANG, Uiwang-si (KR); Jae Won CHOI, Uiwang-si (KR)

(72) Inventors: Kyoung Tae WI, Uiwang-si (KR); Sang Jin KIM, Uiwang-si (KR); Cheol Su KIM, Uiwang-si (KR); Seung Yong YANG, Uiwang-si (KR); Jae Won CHOI, Uiwang-si (KR)

(21) Appl. No.: 13/727,107

(22) Filed: Dec. 26, 2012

(30) Foreign Application Priority Data
Dec. 27, 2011 (KR) 10-2011-0143454

(51) Int. Cl. C09J 163/00

(52) U.S. Cl. 525/523

(57) ABSTRACT

An adhesive film has a die-shear strength of 4 kgf or more/5 mm×5 mm chip, upon chip bonding at 120° C. for 5 seconds, and a storage modulus of 2×10⁶ dyne/cm² or more at 150° C. after curing at 150° C. for 20 minutes.

### CROSS-REFERENCE TO RELATED APPLICATION

The present application claims priority under 35 U.S.C. §119 to Korean Patent Application No. 10-2011-0143454, filed on Dec. 27, 2011, in the Korean Intellectual Property Office, and entitled: “Adhesive Composition For Semiconductor and Adhesive Film Comprising the Same,” which is incorporated by reference herein in its entirety.

### BACKGROUND

1. Field

Embodiments relate to an adhesive composition and an adhesive film comprising the same.

2. Description of the Related Art

High capacity of a semiconductor device may be achieved by circuit integration, in terms of quality, in which the number of cells per unit area is increased, or by packaging, in terms of quantity, in which chips are stacked one above another.

Among packaging techniques, multi-chip packaging (hereinafter, “MCP”) in which several chips are stacked one above another via adhesives and are electrically connected to each other via wire bonding is generally used.

### SUMMARY

Embodiments are directed to an adhesive film having a die-shear strength of 4 kgf or more/5 mm×5 mm chip, upon chip bonding at 120° C. for 5 seconds, and a storage modulus of 2×10⁶ dyne/cm² or more at 150° C. after curing at 150° C. for 20 minutes. An electronic device may include the adhesive film

The adhesive film may have a die shear strength of 6 kgf or more/5 mm×5 mm chip after heating at 150° C. for 20 minutes and IR reflow at 250° C. for 3 minutes.

The adhesive film may have a void area ratio of 10% or less after curing at 150° C. for 20 minutes and molding at 175° C. for 120 seconds.

The adhesive film may include, based on 100 parts by weight of the adhesive film in terms of solid content, about 51 to about 80 parts by weight of a thermoplastic resin, about 5 to about 20 parts by weight of an epoxy resin, about 2 to about 10 parts by weight of a phenolic curing resin, about 2 to about 10 parts by weight of an amine curing resin, about 0.1 to about 10 parts by weight of a curing accelerator.

A weight ratio of the thermoplastic resin to a sum of the epoxy resin, the phenolic curing resin, and the amine curing resin may range from about 51 to about 80 parts by weight: about 9 to about 40 parts by weight. The epoxy resin, the phenolic curing resin, and the amine curing resin may be present as curing systems.

Embodiments are also directed to an adhesive film including a thermoplastic resin, an epoxy resin, a phenolic curing resin, an amine curing resin, and a curing accelerator, wherein the adhesive film provides a die-shear strength of 4 kgf or more/5 mm×5 mm chip, upon chip bonding at 120° C. for 5 seconds. An electronic device may include the adhesive film. An electronic device may include an adhesive film.

The adhesive film may have a curing start temperature of less than 130° C.

The amine curing resin may be an aromatic amine curing resin.

The aromatic amine curing resin may be represented by Formula 1:

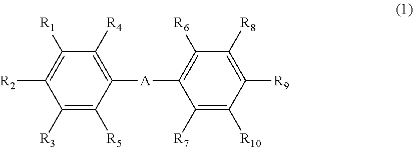

wherein:

A is a single bond or is selected from the group of —CH₂—, —CH₂CH₂—, —SO₂—, —NHCO—, —C(CH₃)₂—, and —O—, and

R₁ to R₁₀ are each independently selected from the group of hydrogen, a C₁-C₄ alkyl group, a C₁-C₄ alkoxy group, and an amine group, with the proviso that at least two of R₁ to R₁₀ include an amine group.

The amine curing resin may be at least one selected from the group of 3,3′-diaminobenzidine, 4,4′-diaminodiphenyl methane, 4,4′ or 3,3′-diaminodiphenyl sulfone, 4,4′-diaminobenzophenone, paraphenylene diamine, metaphenylene diamine, metatoluene diamine, 4,4′-diaminodiphenyl ether, 4,4′ or 3,3′-diaminobenzophenone, 1,4′ or 1,3′-bis(4 or 3-aminocumyl)benzene, 1,4′-bis(4 or 3-aminophenoxy)benzene, 2,2′-bis[4-(4 or 3-aminophenoxy)phenyl]propane, bis[4-(4 or 3-aminophenoxy)phenyl]sulfone, 2,2′-bis[4-(4 or 3-aminophenoxy)phenyl]hexafluorosulfone, 2,2′-bis[4-(4 or 3-aminophenoxy)phenyl]hexafluoropropane, 4,4′-diamino-3,3′,5,5′-tetrabutyldiphenylketone, 4,4′-diamino-3,3′,5,5′-tetraethyldiphenylketone, 4,4′-diamino-3,3′,5,5′-tetra-n-propylenediphenylketone, 4,4′-diamino-3,3′,5,5′-tetraisopropyldiphenylketone, 4,4′-diamino-3,3′,5,5′-tetramethyldiphenylketone, 4,4′-diamino-3,3′,5,5′-tetra-n-propyldiphenylmethane, 4,4′-diamino-3,3′5,5-tetramethyldiphenylmethane, 4,4′-diamino-3,3′5,5′-tetraisopropyldiphenylmethane, 4,4′-diamino-3,3′5,5′-tetraethyldiphenylmethane, 4,4′-diamino-3,3′-dimethyl-5,5′-diethyldiphenylmethane, 4,4′-diamino-3,3′-dimethyl-5,5′-diisopropyldiphenylmethane, 4,4′-diamino-3,3′-diethyl-5,5′-diethyldiphenylmethane, 4,4′-diamino-3,5′-dimethyl-3′,5′-diethyldiphenylmethane, 4,4′-diamino-3,5-dimethyl-3′,5′-diisopropyldiphenylmethane, 4,4′-diamino-3,5-diethyl-3′,5′-dibutyldiphenylmethane, 4,4′-diamino-3,5-diisopropyl-3′,5′-dibutyldiphenylmethane, 4,4′-diamino-3,3′-diisopropyl-5,5′-dibutyldiphenylmethane, 4,4′-diamino-3,3′-dimethyl-5′,5′-dibutyldiphenylmethane, 4,4′-diamino-3,3′-diethyl-5′,5′-dibutyldiphenylmethane, 4,4′-diamino-3,3′-dimethyldiphenylmethane, 4,4′-diamino-3,3′-diethyldiphenylmethane, 4,4′-diamino-3,3′-di-n-propyldiphenylmethane, 4,4′-diamino-3,3′-diisopropyldiphenylmethane, 4,4′-diamino-3,3′-dibutyldiphenylmethane, 4,4′-diamino-3,3′,5-trimethyldiphenylmethane, 4,4′-diamino-3,3′,5-triethyldiphenylmethane, 4,4′-diamino-3,3′,5-tri-n-propyldiphenylmethane, 4,4′-diamino-3,3′,5-triisopropyldiphenylmethane, 4,4′-diamino-3,3′,5-tributyldiphenylmethane, 4,4′-diamino-3-methyl-3′-ethyldiphenylmethane, 4,4′-diamino-3-methyl-3′-isopropyldiphenylmethane, 4,4′-diamino-3-methyl-3′-butyldiphenylmethane, 4,4′-diamino-3-isopropyl-3′-butyldiphenylmethane, 2,2-bis(4-amino-3,5-dimethylphenyl)propane, 2,2-bis(4-amino-3,5-diethylphenyl)propane, 2,2-bis(4-amino-3,5-di-n-propylphenyl)propane, 2,2-bis(4-amino-3,5-diisopropylphenyl)propane, 2,2-bis(4-amino-3,5-dibutylphenyl)propane, 4,4′-diamino-3,3′,5,5′-tetramethyldiphenylbenzanilide, 4,4′-diamino-3,3′,5,5′-tetraethyldiphenylbenzanilide, 4,4′-diamino-3,3′,5,5′-tetra-n-propyldiphenylbenzanilide, 4,4′-diamino-3,3′,5,5′-tetraisopropyldiphenylbenzanilide, 4,4′-diamino-3,3′,5,5′-tetrabutyldiphenylbenzanilide, 4,4′-diamino-3,3′,5,5′-tetramethyldiphenylsulfone, 4,4′-diamino-3,3′,5,5′-tetraethyldiphenylsulfone, 4,4′-diamino-3,3′,5,5′-tetra-n-propyldiphenylsulfone, 4,4′-diamino-3,3′,5,5′-tetraisopropyldiphenylsulfone, 4,4′-diamino-3,3′,5,5′-tetramethyldiphenylether, 4,4′-diamino-3,3′,5,5′-tetraethyldiphenylether, 4,4′-diamino-3,3′,5,5′-tetra-n-propyldiphenylether, 4,4′-diamino-3,3′,5,5′-tetraisopropyldiphenylether, 4,4′-diamino-3,3′,5,5′-tetrabutyldiphenylether, 3,3′-diaminobenzophenone, 3,4-diaminobenzophenone, 3,3′-diaminodiphenylether, 3,3′-diaminodiphenylmethane, 3,4′-diaminodiphenylmethane, 2,2′-diamino-1,2-diphenylethane or 4,4′-diamino-1,2-diphenylethane, 2,4-diaminodiphenylamine, 4,4′-diaminooctafluorobiphenyl, o-dianisidine, 1,5-diaminonaphthalene, 1,8-diaminonaphthalene, 2,3-diaminonaphthalene, pararosanilin, 1,2-diaminoanthraquinone, 1,4-diaminoanthraquinone, 1,5-diaminoanthraquinone, 2,6-diaminoanthraquinone, 1,4-diamino-2,3-dichloroanthraquinone, 1,4-diamino-2,3-dicyano-9,10-anthraquinone, 1,4-diamino-4,8-dihydroxy-9,10-anthraquinone, 3,7-diamino-2,8-dimethyldibenzothiphenesulfone, 2,7-diaminofluorene, and 3,6-diaminocarbazole.

The phenolic curing resin may be represented by Formula 6:

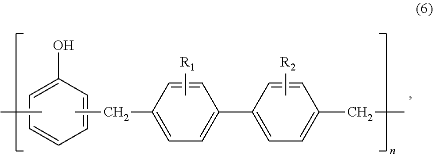

wherein R₁ and R₂ are each independently a C₁-C₆ alkyl group and n ranges from 2 to 100.

The phenolic curing resin may be the at least one selected from the group of a bisphenol resin, a phenol novolac resin, a bisphenol A novolac resin, a xylene resin, a cresol novolac resin, and a phenolic biphenyl-containing resin.

The curing accelerator may include at least one selected from the group of an imidazole curing accelerator and a microcapsule type latent curing agent.

Embodiments are also directed to an adhesive composition including, based on 100 parts by weight of the adhesive film composition in terms of solid content, about 51 to about 80 parts by weight of a thermoplastic resin, about 5 to about 20 parts by weight of an epoxy resin, about 2 to about 10 parts by weight of a phenolic curing resin, about 2 to about 10 parts by weight of an amine curing resin; and about 0.1 to about 10 parts by weight of a curing accelerator. An electronic device may include an adhesive film formed from the adhesive composition.

The curing accelerator may include one or more selected from the group of an imidazole curing accelerator and a microcapsule type latent curing agent.

### BRIEF DESCRIPTION OF THE DRAWING

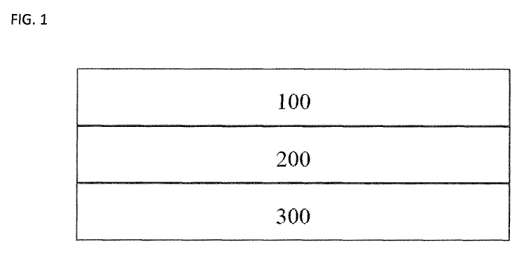

Features will become apparent to those of skill in the art by describing in detail exemplary embodiments with reference to the attached drawing in which FIG. 1 illustrates an electronic device according to an embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

In one aspect, embodiments relate to an adhesive film, such as an adhesive film for electronic devices, i.e., semiconductors, or more particularly, semiconductor chips. The adhesive film has a die-shear strength of 4 kgf or more/5 mm×5 mm chip, upon chip bonding at 120° C. for 5 seconds, and a storage modulus of 2×10⁶ dyne/cm² or more at 150° C. after curing at 150° C. for 20 minutes. Conventionally, PCB baking and PCB plasma processes are carried out to provide sufficient bonding force between a chip and a PCB in a chip bonding process. In the present embodiment, the die-shear strength is determined in consideration of the chip bonding process. The adhesive film according to an embodiment has a die-shear strength of 4 kgf or more/5 mm×5 mm chip through chip bonding only, the chip bonding being at 120° C. for 5 seconds. For example, the adhesive film may have a die-shear strength of 5 kgf or more/5 mm×5 mm chip, so that a sufficient bonding force may be obtained through chip bonding, thereby allowing PCB baking and PCB plasma processes to be omitted.

The die-shear strength may be measured by placing a chip that has a size of 5 mm×5 mm and is laminated on an adhesive film at 60° C., on a 530 μm thick wafer having a size of 10 mm×10 mm, followed by pressing the chip on a hot plate at 120° C. under a load of 10 kgf for 5 seconds.

The adhesive film according to an embodiment may have a void area ratio of 10% or less after curing at 150° C. for 20 minutes and molding at 175° C. for 120 seconds. For example, the adhesive film may have a void area ratio of 7% or less, or 5% or less after the curing and molding. To obtain the void area ratio, a chip (adhesive+chip) (10 mm×10 mm), which is provided with the adhesive film at one side thereof, may be attached to a pretreated PCB at 120° C. under a load of 1 kgf for 1 second, and cured on a hot plate at 150° C. for 20 minutes, followed by EMC molding at 175° C. for 120 seconds. Then, an adhesive layer of the molded sample may be exposed and photographed by a microscope (magnification of 25×) to determine the presence of voids through image analysis. To count the number of voids, a lattice counting method may be used. Specifically, the overall area may be divided into 10 lattices in a longitudinal direction and 10 lattices in a transverse direction, and the number of lattices including a void may be counted and converted into a percentage (%) (void area ratio).

Void area ratio=(void area/total area)×100

According to an embodiment, the adhesive film may have a storage modulus of 2×10⁶ dyne/cm² or more at 150° C. after curing at 150° C. for 20 minutes. The storage modulus is determined in consideration of a wire bonding process after the chip bonding process. Conventionally, a curing process (or semi-curing or B-stage process) may be carried out at 120° C. to 150° C. for about 30 minutes to 1 hour to provide sufficient bonding force upon wire bonding. According to the present embodiment, the adhesive film may have a high storage modulus of 2×10⁶ dyne/cm² or more after simulation of the wire bonding process (curing at 150° C. for 20 minutes). In some implementations, the adhesive film may have a storage modulus of 3×10⁶ dyne/cm² or more, or, for example, 4×10⁶ dyne/cm² or more, so that voids or reliability failure may reduced or prevented even when the curing process (or semi-curing or B-stage process) is omitted or reduced.

The storage modulus may be measured by stacking several sheets of adhesive films at 60° C., cutting the stack of adhesive films into a circular-shaped sample having a thickness of 400 μm to 450 μm and a diameter of 8 mm, and heating the sample on a hot plate at 150° C. for 20 minutes, followed by measurement under a temperature increasing condition in a temperature range from 30° C. to 200° C. at 10° C./minutes using an ARES (advanced rheometric expansion system) measuring device.

The adhesive film may be characterized by a die-shear strength of 6 kgf or more/5 mm×5 mm chip after being heated at 150° C. for 20 minutes and subjected to infrared (IR) reflow at 250° C. for 3 minutes. This condition may be determined through simulation of a process in which solder ball attaching (SBA) is performed immediately after wire bonding without performing a PMC (Post Mold Cure) process. As such, the adhesive film may have a die-shear strength of 6 kgf or more/5 mm×5 mm chip, or, for example, 7 kgf or more/5 mm×5 mm chip after being heated at 150° C. for 20 minutes and subjected to infrared (IR) reflow at 250° C. for 3 minutes, thereby enabling a PMC process to be omitted.

The adhesive film may have a curing residual ratio of 20% or less, as determined by differential scanning calorimetry (DSC). The amount of heat generated after the adhesive film is heated on a hot plate 150° C. for 20 minutes and subjected to IR-reflow at a peak temperature of 250° C. for 3 minutes may be 20% or less of the amount of heat before curing.

The adhesive film may include, based on 100 parts by weight of the adhesive film in terms of solid content, (a) about 51 to about 80 parts by weight of a thermoplastic resin, (b) about 5 to about 20 parts by weight of an epoxy resin, (c) about 2 to about 10 parts by weight of a phenolic curing resin, (d) about 2 to about 10 parts by weight of an amine curing resin, and (e) about 0.1 to about 10 parts by weight of a curing accelerator, wherein the weight ratio of (a):(b)+(c)+(d) may range from about 51 to about 80 parts by weight: about 9 to about 40 parts by weight, the epoxy resin (b), the phenolic curing resin (c) and the amine curing resin (d) being present as curing systems.

An adhesive film composition according to an embodiment includes a thermoplastic resin, an epoxy resin, a phenolic curing resin, an amine curing resin and a curing accelerator, and provides an adhesive film having a die-shear strength of 4 kgf or more/5 mm×5 mm chip, upon chip bonding at 120° C. for 5 seconds.

The adhesive film composition may have a curing start temperature of less than 130° C., for example, less than 120° C. The curing start temperature may be defined as a temperature at which an exothermic peak starts to appear when the adhesive composition is scanned from 0° C. to 300° C. at a temperature elevation rate of 10° C./min.

The amine curing resin may be an aromatic amine curing resin, for example, an aromatic amine curing resin represented by Formula 1:

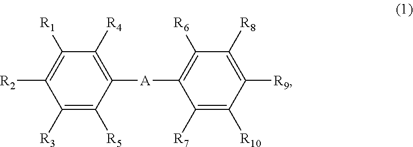

wherein A is a single bond or is selected from the group of —CH₂—, —CH₂CH₂—, —SO₂—, —NHCO—, —C(CH₃)₂—, and —O—, and R₁ to R₁₀ are each independently hydrogen, a C₁-C₄ alkyl group, a C₁-C₄ alkoxy group, and amine groups, with the proviso that at least two of R₁ to R₁₀ include an amine group.

The phenolic curing resin may include a biphenyl group in the main chain. For example, the phenolic curing resin may be a phenolic curing resin represented by Formula 6:

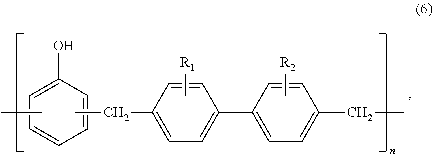

wherein R₁ and R₂ are each independently a C₁-C₆ alkyl group and n ranges from 2 to 100.

The curing accelerator may include an imidazole or microcapsule type latent curing agent, for example, a microcapsule type latent curing agent.

Examples of imidazole curing accelerators include 2-methylimidazole, 2-ethyl-4-methylimidazole, 2-undecylimidazole, 2-heptadecylimidazole, 2-phenylimidazole, 2-phenyl-4-methylimidazole, 1-benzyl-2-methylimidazole, 2-ethylimidazole, 2-isopropylimidazole, 2-phenyl-4-benzylimidazole, 2-phenyl-4,5-dihydroxymethylimidazole, 2-phenyl-4-methyl-5-hydroxymethylimidazole, 2-phenyl-4-benzyl-5-hydroxymethylimidazole, 4-4′-methylenebis-(2-ethyl-5-methylimidazole), 2-aminoethyl-2-methylimidazole, and 1-cyanoethyl-2-phenyl-4,5-di(cyanoethoxymethyl)imidazole. Examples of commercially available imidazole curing accelerators include 2MZ, 2E4MZ, C11Z, C17Z, 2PZ, 2PZ-CN, 2P4MZ, 1B2MZ, 2EZ, 21Z, 2P4BZ, 2PH2-PW, 2P4 MHZ, 2P4BHZ, 2E4MZ-BIS, AMZ, and 2PHZ-CN (Asahi Kasei Corporation). For example, 2-phenyl-4,5-dihydroxymethylimidazole or 2-phenyl-4-methylimidazole may be advantageously used as the imidazole curing accelerator.

A suitable microcapsule type latent curing agent may be used. For example, the microcapsule type latent curing agent may include a microcapsule type latent curing agent disclosed in Korean Patent Publication No. 10-2010-0072030A, the entire disclosure of which is incorporated herein by reference, wherein a core includes amine adducts and a capsule includes a reaction product of a compound containing an isocyanate and an active hydrogen group and/or water; a microcapsule curing agent disclosed in Korean Patent Publication No. 2011-0100235, the entire disclosure of which is incorporated herein by reference, wherein a core contains an imidazole compound, and a shell contains an organic polymer, an inorganic compound, or both, and covers the surface of the core; or a microcapsule latent curing agent disclosed in Korean Patent Publication No. 2008-0040793, the entire disclosure of which is incorporated herein by reference. For example, Novacure® HX-3721, HX-3748, HX-3741, HX-3613, HX-3722, HX-3742, HX-3088, HX-3792, HX-3921HP, HX-4921HP, HX-3922HP, or HX-3932HP may be used. For example, HX-3741, HX-3088, or HX-3792 may be used.

Embodiments also relate to an adhesive film composition that includes: (a) about 51 to about 80 parts by weight of a thermoplastic resin; (b) about 5 to about 20 parts by weight of an epoxy resin; (c) about 2 to about 10 parts by weight of a phenolic curing resin; (d) about 2 to about 10 parts by weight of an amine curing resin; and (e) about 0.1 to about 10 parts by weight of a curing accelerator, based on 100 parts by weight of the adhesive film composition in terms of solid content. In this implementation, the adhesive film composition may further include a silane coupling agent and/or fillers. The silane coupling agent may be present in an amount of about 0.01 to about 5 parts by weight, and the fillers may be present in an amount of about 5 to about 20 parts by weight, based on 100 parts by weight of the adhesive film composition in terms of solid content.

Next, each component of the adhesive film composition, such as the thermoplastic resin, the epoxy resin, the phenolic curing resin, the amine curing resin and the curing accelerator, will be described in detail.

Thermoplastic Resin

Examples of thermoplastic resins suitable for use in the adhesive composition may include polyimide resins, polystyrene resins, polyethylene resins, polyester resins, polyamide resins, butadiene rubbers, acryl rubbers, (meth)acrylate resins, urethane resins, polyphenylene ether resins, polyether imide resins, phenoxy resins, polycarbonate resins, polyphenylene ether resins, modified polyphenylene ether resins, or mixtures thereof. For example, the thermoplastic resin may contain an epoxy group. In some implementations, an epoxy group containing (meth)acrylic copolymer may be used as the thermoplastic resin.

The thermoplastic resin may have a glass transition temperature of about −30° C. to about 80° C., for example, about 5° C. to about 60° C., or for example, about 5° C. to about 35° C. Within these ranges of the thermoplastic resin, the composition may secure high flowability to exhibit excellent void removal capability, and provide high adhesion and reliability.

In some embodiments, the thermoplastic resin may have a weight average molecular weight of about 50,000 to about 5,000,000 g/mol.

The thermoplastic resin may be present in an amount of 51˜80 parts by weight based on 100 parts by weight of the composition in terms of solid content, for example, 55˜75 parts by weight, or for example, 60˜72 parts by weight. When the amount of the thermoplastic resin is more than 51 parts by weight, undesirable void generation may be reduced or avoided and reliability may be enhanced.

Further, the weight ratio of the thermoplastic resin (A) to a mixture of the epoxy resin (B), the phenolic curing agent (C) and the amine curing agent (D) as a curing system, that is, the weight ratio of (A):(B)+(C)+(D), may range from 51˜80 parts by weight: 9˜40 parts by weight, for example, 55˜75 parts by weight: 15˜30 parts by weight. Within these ranges of the components, void generation may be be advantageously suppressed.

Epoxy Resin

The epoxy resin is curable and functions to impart adhesion to the composition.

The epoxy resin may be a liquid epoxy resin, a solid epoxy resin, or a mixture thereof.

Examples of suitable liquid epoxy resins include bisphenol A type liquid epoxy resins, bisphenol F type liquid epoxy resins, tri- or more polyfunctional liquid epoxy resins, rubber-modified liquid epoxy resins, urethane-modified liquid epoxy resins, acrylic modified liquid epoxy resins, or photosensitive liquid epoxy resins. These liquid epoxy resins may be used alone or as a mixture. For example, a bisphenol A type liquid epoxy resin may be used.

The liquid epoxy resin may have an epoxy equivalent weight of about 100 to about 1500 g/eq. For example, the liquid epoxy resin may have an epoxy equivalent weight from about 150 to about 800 g/eq., or, for example, from about 150 to about 400 g/eq. Within this range, a cured product with good adhesion and heat resistance may be obtained while maintaining the glass transition temperature.

The liquid epoxy resin may have a weight average molecular weight ranging from 100 to 1,000 g/mol. This range may be advantageous in terms of high flowability.

The solid epoxy resin may be one that is a solid or quasi-solid at room temperature and has one or more functional groups. The solid epoxy resin may have a softening point (Sp) of about 30° C. to about 100° C. Examples of suitable solid epoxy resins include bisphenol epoxy resins, phenol novolac epoxy resins, o-cresol novolac epoxy resins, polyfunctional epoxy resins, amine epoxy resins, heterocyclic epoxy resins, substituted epoxy resins, naphthol-based epoxy resins, biphenyl-based epoxy resins, or derivatives thereof.

As commercially available solid epoxy resins, examples of bisphenol epoxy resins include YD-017H, YD-020, YD020-L, YD-014, YD-014ER, YD-013K, YD-019K, YD-019, YD-017R, YD-017, YD-012, YD-011H, YD-011S, YD-011, YDF-2004, YDF-2001 (Kukdo Chemical Co., Ltd.), etc. Examples of phenol novolac epoxy resins include EPIKOTE 152 and EPIKOTE 154 (Yuka Shell Epoxy Co., Ltd.); EPPN-201 (Nippon Kayaku Co., Ltd.); DN-483 (Dow Chemical Company); YDPN-641, YDPN-638A80, YDPN-638, YDPN-637, YDPN-644, YDPN-631 (Kukdo Chemical Co., Ltd.), etc. Examples of o-cresol novolac epoxy resins include: YDCN-500-1P, YDCN-500-2P, YDCN-500-4P, YDCN-500-5P, YDCN-500-7P, YDCN-500-8P, YDCN-500-10P, YDCN-500-80P, YDCN-500-80PCA60, YDCN-500-80PBC60, YDCN-500-90P, YDCN-500-90PA75 (Kukdo Chemical Co., Ltd.); EOCN-102S, EOCN-103S, EOCN-104S, EOCN-1012, EOCN-1025, EOCN-1027 (Nippon Kayaku Co., Ltd.); YDCN-701, YDCN-702, YDCN-703, YDCN-704 (Tohto Kagaku Co., Ltd.); Epiclon N-665-EXP (Dainippon Ink and Chemicals, Inc.), etc. Examples of bisphenol novolac epoxy resins include KBPN-110, KBPN-120, KBPN-115 (Kukdo Chemical Co., Ltd.), etc. Examples of multifunctional epoxy resins include Epon 1031S (Yuka Shell Epoxy Co., Ltd.); Araldite 0163 (Ciba Specialty Chemicals); Detachol EX-611, Detachol EX-614, Detachol EX-614B, Detachol EX-622, Detachol EX-512, Detachol EX-521, Detachol EX-421, Detachol EX-411, Detachol EX-321 (NAGA Celsius Temperature Kasei Co., Ltd.); EP-5200R, KD-1012, EP-5100R, KD-1011, KDT-4400A70, KDT-4400, YH-434L, YH-434, YH-300 (Kukdo Chemical Co., Ltd.), etc. Examples of amine epoxy resins include EPIKOTE 604 (Yuka Shell Epoxy Co., Ltd.); YH-434 (Tohto Kagaku Co., Ltd.); TETRAD-X and TETRAD-C (Mitsubishi Gas Chemical Company Inc.); ELM-120 (Sumitomo Chemical Industry Co., Ltd.), etc. Examples of heterocyclic epoxy resins include PT-810 (Ciba Specialty Chemicals). Examples of substituted epoxy resins include: ERL-4234, ERL-4299, ERL-4221, ERL-4206 (UCC Co., Ltd.), etc. Examples of naphthol epoxy resins include: Epiclon HP-4032, Epiclon HP-4032D, Epiclon HP-4700, and Epiclon HP-4701 (Dainippon Ink and Chemicals, Inc.). Examples of non-phenolic epoxy resins include YX-4000H (Japan Epoxy Resin), YSLV-120TE, GK-3207 (Nippon steel chemical), NC-3000 (Nippon Kayaku), etc. These epoxy resins may be used alone or as mixtures.

The epoxy resin may be present in an amount of about 5 to about 20 parts by weight, for example, about 7 to about 15 parts by weight, based on 100 parts by weight of the composition in terms of solid content. Within this range, high reliability and excellent mechanical properties may be attained.

Curing Agents

The curing agents suitable for use in the adhesive composition may be two kinds of curing agents having different reaction temperature zones.

In some embodiments, the curing agents may be a phenolic curing agent and an amine curing agent.

A suitable phenolic curing agent may be used without limitation. For example, bisphenol resins, which contain two or more phenolic hydroxyl groups in a single molecule and exhibit excellent electrolytic corrosion resistance upon hydrolysis, such as bisphenol A, bisphenol F, bisphenol S, or the like; phenol novolac resins; bisphenol A novolac resins; and phenolic resins such as xylene, cresol novolac, biphenyl resins, or the like, may be used. As commercially available phenolic curing agents, examples of phenolic curing agents include H-1, H-4, HF-1M, HF-3 M, HF-4M, and HF-45 (Meiwa Plastic Industries Co., Ltd.); examples of paraxylene phenolic curing agents include MEH-78004S, MEH-7800SS, MEH-7800S, MEH-7800M, MEH-7800H, MEH-7800HH, or MEH-78003H (Meiwa Plastic Industries Co., Ltd.), PH-F3065 (Kolong Industries Co., Ltd.); examples of biphenyl curing agents include MEH-7851SS, MEH-7851S, MEH-7851M, MEH-7851H, MEH-78513H, MEH-78514H (Meiwa Plastic Industries Co., Ltd.), or KPH-F4500 (Kolong Industries Co., Ltd.); and examples of triphenylmethyl curing agents include MEH-7500, MEH-75003S, MEH-7500SS, MEH-7500S, MEH-7500H (Meiwa Plastic Industries Co., Ltd.), etc. These may be used alone or as mixtures thereof.

The phenolic curing agent suitable for use in the adhesive composition may have a structure represented by Formula 6:

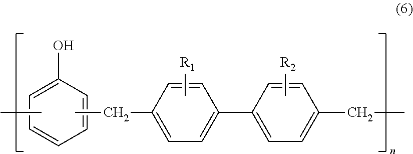

wherein R₁ and R₂ are each independently a C₁-C₆ alkyl group and n ranges from 2 to 100.

Examples of the phenolic curing agents include MEH-7851SS, MEH-7851S, MEH-7851M, MEH-7851H or MEH-78514H, which are commercially available from Meiwa Plastic Industries Co., Ltd.

The phenolic curing agent may be present in an amount of about 2 to about 10 parts by weight based on 100 parts by weight of the adhesive film composition in terms of solid content.

The amine curing agent may be an aromatic amine curing agent that provides a curing rate adjustment. For example, the amine curing resin may be an aromatic compound having two or more amine groups in a single molecule, without being limited thereto. The amine curing agent may be one represented by, for example, a compound represented in one of Formulae 1 to 5:

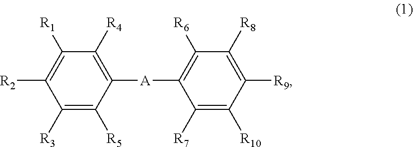

wherein A is a single bond or is selected from the group consisting of —CH₂CH₂—, —SO₂—, —NHCO—, —C(CH₃)₂—, and —O—, R₁ to R₁₀ are each independently hydrogen, a C₁-C₄ alkyl group, a C₁-C₄ alkoxy group, and an amine group, with the proviso that at least two of R1 to R10 include an amine group;

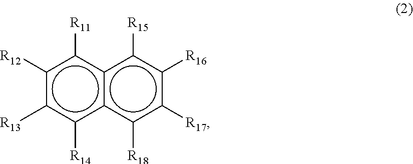

wherein R₁₁ to R₁₈ are each independently a C₁ to C₄ alkyl group, an alkoxy group, a hydroxyl group, a cyanide group, halogen or an amine group, with the proviso that at least one R₁₁ to R₁₈ includes an amine group;

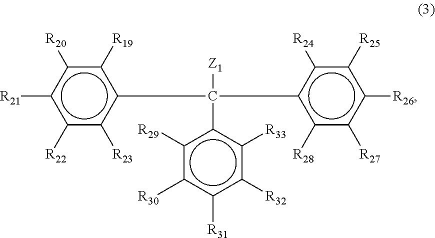

wherein Z₁ is hydrogen, a C1 to C4 alkyl group, an alkoxy group, or a hydroxyl group; R₁₉ to R₃₃ are each independently hydrogen, a C₁ to C₄ alkyl group, an alkoxy group, a hydroxyl group, a cyanide group, a halogen or an amine group, with the proviso that at least one of R₁₉ to R₃₃ includes an amine group;

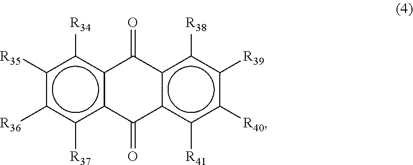

wherein R₃₄ to R₄₁ are independently hydrogen, a C₁ to C₄ alkyl group, an alkoxy group, a hydroxyl group, a cyanide group, a halogen, or an amine group, with the proviso that at least one of R₃₄ to R₄₁ includes an amine group; or

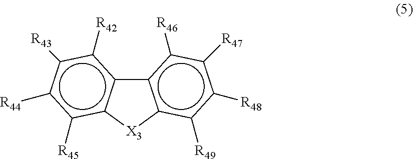

wherein X₃ is one selected from the group consisting of —CH₂—, —NH—, —SO₂—, —S—, and -0-; and R₄₂ to R₄₉ are independently hydrogen, a C1 to C4 alkyl group, an alkoxy group, a hydroxyl group, a cyanide group, a halogen, or an amine group, with the proviso that at least one of R₄₂ to R₄₉ includes an amine group.

Example of the curing agent of Formula 1 include 3,3′-diaminobenzidine, 4,4′-diaminodiphenyl methane, 4,4′ or 3,3′-diaminodiphenyl sulfone, 4,4′-diaminobenzophenone, paraphenylene diamine, metaphenylene diamine, metatoluene diamine, 4,4′-diaminodiphenyl ether, 4,4′ or 3,3′-diaminobenzophenone, 1,4′ or 1,3′-bis(4 or 3-aminocumyl)benzene, 1,4′ bis(4 or 3-aminophenoxy)benzene, 2,2′-bis[4-(4 or 3-aminophenoxy)phenyl]propane, bis[4-(4 or 3-aminophenoxy)phenyl]sulfone, 2,2′-bis[4-(4 or 3-aminophenoxy)phenyl]hexafluorosulfone, 2,2′-bis[4-(4 or 3-aminophenoxy)phenyl]hexafluoropropane, 4,4′-diamino-3,3′,5,5′-tetrabutyldiphenylketone, 4,4′-diamino-3,3′,5,5′-tetraethyldiphenylketone, 4,4′-diamino-3,3′,5,5′-tetra-n-propylenediphenylketone, 4,4′-diamino-3,3′,5,5′-tetraisopropyldiphenylketone, 4,4′-diamino-3,3′,5,5′-tetramethyldiphenylketone, 4,4′-diamino-3,3′,5,5′-tetra-n-propyldiphenylmethane, 4,4′-diamino-3,3′5,5-tetramethyldiphenylmethane, 4,4′-diamino-3,3′5,5′-tetraisopropyldiphenylmethane, 4,4′-diamino-3,3′5,5′-tetraethyldiphenylmethane, 4,4′-diamino-3,3′-dimethyl-5,5′-diethyldiphenylmethane, 4,4′-diamino-3,3′-dimethyl-5,5′-diisopropyldiphenylmethane, 4,4′-diamino-3,3′-diethyl-5,5′-diethyldiphenylmethane, 4,4′-diamino-3,5′-dimethyl-3′,5′-diethyldiphenylmethane, 4,4′-diamino-3,5-dimethyl-3′,5′-diisopropyldiphenylmethane, 4,4′-diamino-3,5-diethyl-3′,5′-dibutyldiphenylmethane, 4,4′-diamino-3,5-diisopropyl-3′,5′-dibutyldiphenylmethane, 4,4′-diamino-3,3′-diisopropyl-5,5′-dibutyldiphenylmethane, 4,4′-diamino-3,3′-dimethyl-5′,5′-dibutyldiphenylmethane, 4,4′-diamino-3,3′-diethyl-5′,5′-dibutyldiphenylmethane, 4,4′-diamino-3,3′-dimethyldiphenylmethane, 4,4′-diamino-3,3′-diethyldiphenylmethane, 4,4′-diamino-3,3′-di-n-propyldiphenylmethane, 4,4′-diamino-3,3′-diisopropyldiphenylmethane, 4,4′-diamino-3,3′-dibutyldiphenylmethane, 4,4′-diamino-3,3′,5-trimethyldiphenylmethane, 4,4′-diamino-3,3′,5-triethyldiphenylmethane, 4,4′-diamino-3,3′,5-tri-n-propyldiphenylmethane, 4,4′-diamino-3,3′,5-triisopropyldiphenylmethane, 4,4′-diamino-3,3′,5-tributyldiphenylmethane, 4,4′-diamino-3-methyl-3′-ethyldiphenylmethane, 4,4′-diamino-3-methyl-3′-isopropyldiphenylmethane, 4,4′-diamino-3-methyl-3′-butyldiphenylmethane, 4,4′-diamino-3-isopropyl-3′-butyldiphenylmethane, 2,2-bis(4-amino-3,5-dimethylphenyl)propane, 2,2-bis(4-amino-3,5-diethylphenyl)propane, 2,2-bis(4-amino-3,5-di-n-propylphenyl)propane, 2,2-bis(4-amino-3,5-diisopropylphenyl)propane, 2,2-bis(4-amino-3,5-dibutylphenyl)propane, 4,4′-diamino-3,3′,5,5′-tetramethyldiphenylbenzanilide, 4,4′-diamino-3,3′,5,5′-tetraethyldiphenylbenzanilide, 4,4′-diamino-3,3′,5,5′-tetra-n-propyldiphenylbenzanilide, 4,4′-diamino-3,3′,5,5′-tetraisopropyldiphenylbenzanilide, 4,4′-diamino-3,3′,5,5′-tetrabutyldiphenylbenzanilide, 4,4′-diamino-3,3′,5,5′-tetramethyldiphenylsulfone, 4,4′-diamino-3,3′,5,5′-tetraethyldiphenylsulfone, 4,4′-diamino-3,3′,5,5′-tetra-n-propyldiphenylsulfone, 4,4′-diamino-3,3′,5,5′-tetraisopropyldiphenylsulfone, 4,4′-diamino-3,3′,5,5′-tetramethyldiphenylether, 4,4′-diamino-3,3′,5,5′-tetraethyldiphenylether, 4,4′-diamino-3,3′,5,5′-tetra-n-propyldiphenylether, 4,4′-diamino-3,3′,5,5′-tetraisopropyldiphenylether, 4,4′-diamino-3,3′,5,5′-tetrabutyldiphenylether, 3,3′-diaminobenzophenone, 3,4-diaminobenzophenone, 3,3′-diaminodiphenylether, 3,3′-diaminodiphenylmethane, 3,4′-diaminodiphenylmethane, 2,2′-diamino-1,2-diphenylethane or 4,4′-diamino-1,2-diphenylethane, 2,4-diaminodiphenylamine, 4,4′-diaminooctafluorobiphenyl, o-dianisidine, or the like.

Examples of the curing agent of Formula 2 include 1,5-diaminonaphthalene, 1,8-diaminonaphthalene, 2,3-diaminonaphthalene, or the like. Examples of the curing agent of Formula 3 include pararosaniline or the like. Examples of the curing agent of Formula 4 include 1,2-diaminoanthraquinone, 1,4-diaminoanthraquinone, 1,5-diaminoanthraquinone, 2,6-diaminoanthraquinone, 1,4-diamino-2,3-dichloroanthraquinone, 1,4-diamino-2,3-dicyano-9,10-anthraquinone, 1,4-diamino-4,8-dihydroxy-9,10-anthraquinone, or the like. Examples of the curing agent of Formula 5 include 3,7-diamino-2,8-dimethyldibenzothiphenesulfone, 2,7-diaminofluorene, 3,6-diaminocarbazole, or the like.

The amine curing resin may be present in an amount of about 2 to about 10 parts by weight based on 100 parts by weight of the adhesive film composition in terms of solid content.

Curing Accelerator

The adhesive composition may include a curing accelerator. The curing accelerator suitable for use in the composition according to the present embodiment serves to reduce a curing time of the epoxy resin during a semiconductor process. A suitable curing accelerator known in the art may be used. For example, melamine, imidazole or microcapsule type latent curing catalysts, or triphenylphosphne curing catalysts may be used. For example, imidazole or microcapsule type latent curing agents may be used. For example, a microcapsule type latent curing agent may be used.

Examples of imidazole curing accelerators suitable for use in the adhesive composition include 2-methylimidazole, 2-ethyl-4-methylimidazole, 2-undecylimidazole, 2-heptadecylimidazole, 2-phenylimidazole, 2-phenyl-4-methylimidazole, 1-benzyl-2-methylimidazole, 2-ethylimidazole, 2-isopropylimidazole, 2-phenyl-4-benzylimidazole, 2-phenyl-4,5-dihydroxymethylimidazole, 2-phenyl-4-methyl-5-hydroxymethylimidazole, 2-phenyl-4-benzyl-5-hydroxymethylimidazole, 4-4′-methylenebis-(2-ethyl-5-methylimidazole), 2-aminoethyl-2-methylimidazole, 1-cyanoethyl-2-phenyl-4,5-di(cyanoethoxymethyl)imidazole, or the like. Examples of commercially available imidazole curing accelerators include 2MZ, 2E4MZ, C 11Z, C17Z, 2PZ, 2PZ-CN, 2P4MZ, 1B2MZ, 2EZ, 21Z, 2P4BZ, 2PH2-PW, 2P4 MHZ, 2P4BHZ, 2E4MZ-BIS, AMZ, or 2PHZ-CN (Asahi Kasei Corporation). For example, 2-phenyl-4,5-dihydroxymethylimidazole or 2-phenyl-4-methylimidazole may be advantageously used as the imidazole curing accelerator.

Examples of the microcapsule type latent curing agents suitable for use in the adhesive composition include a microcapsule type latent curing agent disclosed in Korean Patent Publication No. 10-2010-0072030A, the entire disclosure of which is incorporated herein by reference, wherein a core includes amine adducts and a capsule includes a reaction product of a compound containing an isocyanate and an active hydrogen group and/or water; a microcapsule curing agent disclosed in Korean Patent Publication No. 2011-0100235, the entire disclosure of which is incorporated herein by reference, wherein a core contains an imidazole compound, and a shell contains an organic polymer, an inorganic compound, or both, and covers the surface of the core; or a microcapsule latent curing agent disclosed in Korean Patent Publication No. 2008-0040793, the entire disclosure of which is incorporated herein by reference. For example, Novacure® HX-3721, HX-3748, HX-3741, HX-3613, HX-3722, HX-3742, HX-3088, HX-3792, HX-3921HP, HX-4921HP, HX-3922HP, or HX-3932HP may be used. For example, HX-3741, HX-3088, or HX-3792 may be used.

Examples of the phosphine-based curing catalyst include TBP, TMTP, TPTP, TPAP, TPPO, DPPE, DPPP, and DPPB, which are commercially available from HOKKO Chemical Industry Co., Ltd.

The curing accelerator may be present in an amount of about 0.1 to about 10 parts by weight, for example, 0.3-7 parts by weight, based on 100 parts by weight of the adhesive film composition. Within this range of the curing accelerator, high heat resistance, flowability and connection performance may be attained without causing rapid reaction of the epoxy resin.

Silane Coupling Agent

The adhesive composition may further include a silane coupling agent. The silane coupling agent may function as an adhesion promoter to enhance adhesion between the surface of an inorganic material, such as fillers, and the organic materials via chemical coupling therebetween during blending of the composition.

A suitable silane coupling agent may be used in the adhesive composition. Examples thereof include: epoxy group-containing silane coupling agents, such as 2-(3,4-epoxycyclohexyl)-ethyltrimethoxysilane, 3-glycidoxytrimethoxysilane, or 3-glycidoxypropyltriethoxysilane; amine group-containing silane coupling agents, such as N-2-(aminoethyl)-3-aminopropylmethyldimethoxysilane, N-2-(aminoethyl)-3-aminopropyltrimethoxysilane, N-2-(aminoethyl)-3-aminopropyltriethoxysilane, 3-aminopropyltrimethoxysilane, 3-aminopropyltriethoxysilane, 3-triethoxysilyl-N-(1,3-dimethylbutylidene)propylamine or N-phenyl-3-aminopropyltrimethoxysilane; mercapto-containing silane coupling agents, such as 3-mercaptopropylmethyldimethoxysilane or 3-mercaptopropyltriethoxysilane; or isocyanate-containing silane coupling agents, such as 3-isocyanatepropyltriethoxysilane. These silane coupling agents may be used alone or as mixtures thereof.

The coupling agent may be present in an amount of about 0.01 to about 5 parts by weight, for example about 0.1 to about 3 parts by weight, or, for example, about 0.5 to about 2 parts by weight, based on 100 parts by weight of the adhesive composition in terms of solid content. Within this range, high adhesion reliability may be obtained and the occurrence of bubbles can be reduced.

Filler

The adhesive composition may further include fillers.

Examples of fillers suitable for use in the adhesive composition include: metal powders, such as gold, silver, copper or nickel powders; or a material derived from metals and/or non-metals, such as alumina, aluminum hydroxide, magnesium hydroxide, calcium carbonate, magnesium carbonate, calcium silicate, magnesium silicate, calcium oxide, magnesium oxide, aluminum oxide, aluminum nitride, silica, boron nitride, titanium dioxide, glass, iron oxide, or ceramics. For example, silica may be used.

There is no particular restriction as to the shape and size of the fillers. Spherical silica or amorphous silica may be used as the filler. The particle size of the silica may range from about 5 nm to about 20 μm.

The fillers may be present in an amount of about 1 to about 30 parts by weight, for example 5˜25 parts by weight, based on 100 parts by weight of the adhesive composition. Within this range, high flowability, film-forming properties and adhesion can be obtained.

Solvent

The adhesive composition may further include a solvent. The solvent may serve to reduce the viscosity of the adhesive composition, thereby facilitating formation of an adhesive film. Specific examples of solvents suitable for use in the adhesive composition include organic solvents such as toluene, xylene, propylene glycol monomethyl ether acetate, benzene, acetone, methyl ethyl ketone, tetrahydrofuran, dimethylformamide, or cyclohexanone.

Embodiments also relate to an adhesive film formed from the adhesive composition. There may be no need for special apparatus or equipment for forming an adhesive film using the adhesive composition, and a suitable method may be used to manufacture the adhesive film. For example, the respective components may be dissolved in a solvent, and sufficiently kneaded using a bead-mill, followed by depositing the resultant on a polyethylene terephthalate (PET) film subjected to release treatment, and drying in an over at 100° C. for 1030 minutes to prepare an adhesive film having a suitable thickness.

In one embodiment, the adhesive film may include a base film, an adhesive layer, a bonding layer, and a protective film, which are sequentially stacked in this order.

The adhesive film may have a thickness of about 5 um to about 200 um, for example, from about 10 um to about 100 um. Within this range, the adhesive film may exhibit sufficient adhesion while providing economic feasibility. In an implementation, the adhesive film may have a thickness of about 15 um to about 60 um.

In a further aspect, embodiments provide an electronic device, for example, a semiconductor device, such as a semiconductor chip, that is connected by the adhesive film.

The electronic device may include a substrate, the adhesive film attached to a chip mounting surface of the substrate, and a semiconductor chip mounted on the adhesive film. For example, FIG. 1 illustrates a chip 100 attached to the substrate (e.g., a wiring substrate or another chip) 300 by using the adhesive film 200. A suitable substrate and semiconductor chip may be used. Further, a suitable method for manufacturing the electronic device may be used.

The following Examples and Comparative Examples are provided in order to highlight characteristics of one or more embodiments, but it is to be understood that the Examples and Comparative Examples are not to be construed as limiting the scope of the embodiments, nor are the Comparative Examples to be construed as being outside the scope of the embodiments. Further, it is to be understood that the embodiments are not limited to the particular details described in the Examples and Comparative Examples.

### EXAMPLE

### Examples 1-2

### Preparation of Adhesive Composition

A solvent (cyclohexanone) was added to a thermoplastic resin, an epoxy resin, a phenolic curing agent, an amine curing resin, a curing accelerator, fillers, and a silane coupling agent, in the amounts listed in Table 1, such that the solid content in the solution was 20% by weight, followed by sufficiently kneading using a bead-mill, thereby preparing an adhesive composition.

Comparative Examples 1-3: Preparation of adhesive composition

Adhesive compositions for semiconductor were prepared in the same manner as in Examples 1 and 2, except for using the components and amounts listed in Table 2.

Specification of respective components used in the examples and the comparative examples were as follows:

TABLE 1

| | | | Comparative | Comparative | Comparative |
|---|---|---|---|---|---|
| | Example 1 | Example 2 | Example 1 | Example 2 | Example 3 |
| Thermoplastic resin⁽¹⁾ | 70 | 70 | 70 | 70 | 50 |
| Epoxy resin⁽²⁾ | 8 | 8 | 8 | 8 | 16 |
| Epoxy resin⁽³⁾ | 5 | 5 | 5 | 5 | 10 |
| Phenolic curing resin⁽⁴⁾ | 4 | 4 | | 7 | 8 |
| Amine curing resin⁽⁵⁾ | 3 | 3 | 7 | | 6 |
| Silane coupling agent⁽⁶⁾ | 1 | 1 | 1 | 1 | 1 |
| Curing accelerator⁽⁷⁾ | 0.5 | | 0.5 | 0.5 | 0.5 |
| Curing accelerator⁽⁸⁾ | | 0.5 | | | |
| Filler⁽⁹⁾ | 8.5 | 8.5 | 8.5 | 8.5 | 8.5 |
| Total (parts by weight) | 100 | 100 | 100 | 100 | 100 |

⁽¹⁾Thermoplastic resin: SG-P3 (Nagase Chemtex Co., Ltd.)
⁽²⁾Epoxy resin: YDCN-500-90P (Kukdo Chemical Co., Ltd.)
⁽³⁾Epoxy resin: EPPN-502H (Nippon Kayaku Co., Ltd.)
⁽⁴⁾Phenolic curing resin: HF-1M (Eq.: 106, Meiwa Chemicals Co., Ltd.)
⁽⁵⁾Amine curing resin: DDM (Tokyo Chemical Industries Co., Ltd.)
⁽⁶⁾Silane coupling agent: KBM-403 (Shinetsu Co., Ltd.)
⁽⁷⁾Curing accelerator: 2PZ-CN (HOKKO Chemical Industry Co., Ltd.)
⁽⁸⁾Curing accelerator: HXA-3792 (Asahi Co., Ltd.)
⁽⁹⁾Filler: R-972 (Degussa GmbH)
⁽¹⁰⁾Solvent: Cyclohexanone

### Preparation of adhesive film

Each of the adhesive compositions prepared in Examples 1 and 2 and

Comparative Examples 1, 2 and 3 was deposited on a PET film subjected to releasing treatment using an applicator, followed by drying in an oven at 100° C. for 1030 minutes, thereby providing a 60 um thick adhesive film.

Experimental Example: Evaluation of physical properties of adhesive film prepared using adhesive composition in Examples and Comparative Examples

The physical properties of each of the adhesive films prepared using the adhesive compositions of Examples 1 and 2 and Comparative Examples 1, 2 and 3 were evaluated by the following methods, and results are shown in Table 2.

TABLE 2

| | | | | Comparative | Comparative | Comparative |
|---|---|---|---|---|---|---|
| Item | Unit | Example 1 | Example 2 | Example 1 | Example 2 | Example 3 |
| Die shear strength | Kgf/chip | 5.4 | 6.8 | 0.6 | 4.3 | 7.5 |
| after chip-attach (1) | | | | | | |
| Curing start | ° C. | 110 | 112 | 172 | 147 | 135 |
| temperature (2) | | | | | | |
| Storage modulus | 10⁶ dyne/cm² | 4.22 | 4.9 | 1.2 | 3.92 | 4.51 |
| (150° C.) (3) | | | | | | |
| Melt viscosity | 10⁻⁶ poise | 4.31 | 4.98 | 1.3 | 4.03 | 4.95 |
| (175° C.) (7) | | | | | | |
| Die shear strength | Kgf/chip | 7.7 | 8.1 | 0.94 | 7.6 | 8.3 |
| after reflow (4) | | | | | | |
| Curing residual ratio | % | 16.65 | 0 | 61.97 | 13.5 | 12.8 |
| after reflow (4) | | | | | | |
| Void area ratio after | % | 5 | 7 | 2 | 35 | 45 |
| molding (6) | | | | | | |

(1) Die-shear strength: A 530 μm thick wafer was cut into chips having a size of 5×5 mm. The chips were laminated with each of the adhesive films at 60° C., and were cut to leave behind a bonded portion only. An upper chip having a size of 5×5 mm was placed on a wafer having a size of 10×10 mm, followed by application of a force of 10 kgf on a hot plate at 120° C. for 5 seconds. Then, the die shear strength was measured using a DAGE 4000 bond-tester. Results are shown in Table 2

(2) Curing start temperature: The amount of heat generated for curing the prepared adhesive composition was measured using DSC at a temperature elevation rate of 10° C./min while scanning from 0° C. to 300° C. until an exothermic peak appeared.

(3) Storage modulus: Several sheets of adhesive films were laminated at 60° C. and cut to prepare a circular sample having a diameter of 8 mm and a thickness of about 400450 um. Then, the sample was heated on a hot plate at 150° C. for 20 minutes and the storage modulus of the sample was measured in a temperature range from 30° C. to 200° C. using ARES. The storage modulus at 150° C. is shown in Table 2. Here, the temperature elevation rate was 10° C./min.

(4) Die shear strength after reflow: After preparing the sample for measuring the die shear strength (1), the sample was heated on a hot plate at 150° C. for 20 minutes and subjected to IR reflow at a peak temperature of 250° C. for 3 minutes. Then, the die shear strength was measured at 260° C. using a DAGE 4000.

(5) Curing residual ratio: The prepared adhesive composition was heated on a hot plate at 150° C. for 20 minutes and subjected to IR reflow at a peak temperature of 250° C. for 3 minutes. Then, the amount of heat generated during curing was measured using DSC and divided by an initial amount of heat for curing to calculate the curing residual ratio. The initial amount of heat of the adhesive composition was measured using DSC before curing on the hot plate at 150° C. for 20 minutes.

(6) Void area ratio after molding: With a polished wafer placed on a hot plate of a mounter and subjected to removal of foreign matter using isopropyl alcohol (IPA), a mirror plane of the wafer was placed on an adhesive surface of an adhesive film. Here, a mounter temperature was set to 60° C., which is a general surface temperature. The wafer-adhesive film assembly was cut to a chip size of 10×10 mm by sawing, and attached at 120° C. and 1 kgf/1 sec to a PCB, which had been subjected to pre-treatment under conditions of Table 3, thereby preparing chips each having an adhesive on one side thereof.

TABLE 3

PCB: 62 mm one shot PCB
PCB baking: in an oven at 120° C. for 1 hour
Plasma treatment after baking

Then, the prepared sample was subjected to 1 cycle of curing on a hot plate at 150° C. for 20 minutes and EMC molding was performed under conditions of Table 4, followed by measurement of the proportion of voids.

TABLE 4
EMC Tablet: Cheil Industries EMC SG-8500BC

| Mold | Clamp | Transfer | Transfer | Curing |
|---|---|---|---|---|
| temperature | pressure | pressure | time | time |
| 175° C. | 30 ton | 1.1 ton | 18 sec | 60 sec |

Then, the resultant was divided into respective units using a singulation saw, followed by removal of PCB and grinding using a grinder until the adhesive layer of the adhesive film was exposed, for measurement of the void proportion after molding. Here, in order to facilitate void observation, the resultant was ground such that a solder resist layer of the PCB partially remained to the point of being semi-transparent.

After grinding, the exposed adhesive layer was photographed using a microscope (magnification: 25×) and the presence of voids was inspected through image analysis. To measure and digitize the number of voids, a lattice counting method was used. Specifically, the total area of the sample was divided into 10 lattice rows and 10 lattice columns, and the number of lattices including voids was counted and converted into % (void area ratio).

Void area ratio=(void area/total area)×100

(7) Melt viscosity: Several sheets of adhesive films were laminated at 60° C. and cut to prepare a circular sample having a diameter of 8 mm. The sample had a thickness of about 400˜450 um. Then, the sample was heated on a hot plate at 150° C. for 20 minutes and the melt viscosity was measured in a temperature range from 30° C. to 200° C. using ARES.

Referring to Table 2, it can be seen that the adhesive compositions of Examples 1 and 2 had a die shear strength of 4 kgf or more/5 mm×5 mm chip only through chip bonding at 120° C. for 5 seconds, and a high storage modulus of 2×10⁶ dyne/cm² or more after simulation of wire bonding (curing at 150° C. for 20 minutes), thereby providing sufficient adhesion through chip bonding alone, without requiring a PCB baking and PCB plasma process. In addition, even in the case of omitting or reducing the curing process (or semi-curing or B-stage process), there was no void generation or reliability deterioration. The adhesive compositions of Examples 1 and 2 had a die-shear strength of 6 kgf or more/5 mm×5 mm chip after being heated at 150° C. for 20 minutes and then subjected to IR reflow at 250° C. for 3 minutes. Accordingly, it was possible to omit the PMC process.

On the other hand, with respect to the adhesive composition of Comparative Example 1, which used a single curing system of the amine curing agent, a sufficient crosslinking structure was not formed through heating at 150° C. for 20 minutes and the storage modulus was low, thereby causing cracks in reflow resistance testing. The adhesive composition of Comparative Example 2, which used a single curing system of the phenolic curing agent, and the adhesive composition of Comparative Example 3, using 51 wt % or less of the thermoplastic resin, did not provide the same levels of void generation and reliability as the adhesive compositions of Examples 1 and 2.

By way of summation and review, to ensure sufficient bonding force between a chip and a printed circuit board (PCB) in a chip bonding process, PCB baking and PCB plasma processes may be performed. In addition, after chip bonding at 120° C. for a few seconds, a curing process (or semi-curing or B-stage process) may be carried out to ensure sufficient bonding force upon wire bonding. Then, after wire bonding at 150° C. for 2 to 20 minutes, the resultant may be subjected to EMC molding, followed by post-mold curing (PMC) at 175° C. for 2 hours.

PCB baking processes, PCB plasma processes, post-curing processes (or semi-curing or B-stage process) and post-mold curing processes used in a chip bonding process are individual processes. As such, it may be difficult to reduce the amount of time and the number of workers used to carry out these processes, thereby reducing productivity.

Accordingly, in order to improve productivity in the manufacture of semiconductors, an in-line process wherein chip bonding and wire bonding are continuously carried out while a PCB is transferred on a rail is desirable. Thus, development of a bonding film for semiconductors that can be applied to the in-line process is desirable. Particularly, in the in-line process, a thermal procedure for allowing a bonding layer to form a sufficient crosslinking structure may be significantly reduced. Accordingly, a composition that allows rapid curing, even under the conditions that the curing process (or semi-curing or B-stage process) and/or the PMC process are omitted or curing process time is reduced, is desirable such that bonding failure, chip separation and deterioration in reliability may be reduced or prevented during wire bonding.

Adhesive film compositions may include a thermoplastic resin, an epoxy resin, a phenolic epoxy resin curing agent, a curing accelerator, a coupling agent, and fillers. However, with such adhesive film compositions that only employ a phenol curing resin as the curing agent, the curing process may progresses too slowly. Thus, these adhesive film compositions may not be suited to a process wherein the curing process (or semi-curing or B-stage process) and/or the PMC process are omitted or where a rapid bonding is desired.

In contrast, embodiments may provide an adhesive composition that exhibit sufficient strength through only a chip bonding process, such that a PCB bake process and a PCB plasma process may be omitted. The adhesive composition may have high bonding characteristics through an increase in the curing rate and may be partially cured during wire bonding upon application to an in-line process for reducing process time. Thereby, a curing process (or semi-curing or B-stage) may be omitted or reduced. An adhesive composition according to present embodiments may exhibit sufficient adhesive strength and elasticity to be applied to an in-line process even in the case where a curing process after chip bonding (or semi-curing or B-stage process), or a PMC process are omitted or reduced, and an adhesive film including the same. For the adhesive composition according to embodiments, a phenolic resin and an amine curing resin are used together as curing agents to permit omission or reduction of the curing process. An imidazole curing agent or a microcapsule type latent curing agent may be used as a curing accelerator to increase curing rate. According to embodiments, an adhesive film may be provided including the adhesive composition.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An adhesive film having a die-shear strength of 4 kgf or more/5 mm×5 mm chip, upon chip bonding a at 120° C. for 5 seconds, and a storage modulus of 2×10⁶ dyne/cm² or more at 150° C. after curing at 150° C. for 20 minutes.

2. The adhesive film claimed as in claim 1, wherein the adhesive film has a die shear strength of 6 kgf or more/5 mm×5 mm chip after heating at 150° C. for 20 minutes and IR reflow at 250° C. for 3 minutes.

3. The adhesive film claimed as in claim 1, wherein the adhesive film has a void area ratio of 10% or less after curing at 150° C. for 20 minutes and molding at 175° C. for 120 seconds.

4. The adhesive film claimed as in claim 1, wherein the adhesive film includes, based on 100 parts by weight of the adhesive film in terms of solid content:
about 51 to about 80 parts by weight of a thermoplastic resin;
about 5 to about 20 parts by weight of an epoxy resin;
about 2 to about 10 parts by weight of a phenolic curing resin;
about 2 to about 10 parts by weight of an amine curing resin; and
about 0.1 to about 10 parts by weight of a curing accelerator.

5. The adhesive film claimed as in claim 4, wherein a weight ratio of the thermoplastic resin to a sum of the epoxy resin, the phenolic curing resin, and the amine curing resin ranges from about 51 to about 80 parts by weight: about 9 to about 40 parts by weight, the epoxy resin, the phenolic curing resin, and the amine curing resin being present as curing systems.

6. An adhesive film, comprising a thermoplastic resin, an epoxy resin, a phenolic curing resin, an amine curing resin, and a curing accelerator, wherein the adhesive film provides an adhesive film having a die-shear strength of 4 kgf or more/5 mm×5 mm chip, upon chip bonding at 120° C. for 5 seconds.

7. The adhesive film claimed as in claim 6, wherein the adhesive film has a curing start temperature of less than 130° C.

8. The adhesive film claimed as in claim 6, wherein the amine curing resin is an aromatic amine curing resin.

9. The adhesive film claimed as in claim 8, wherein the aromatic amine curing resin is represented by Formula 1: 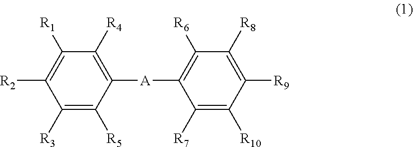
wherein:
A is a single bond or is selected from the group of —CH₂—, —CH₂CH₂—, —SO₂—, —NHCO—, —C(CH₃)₂—, and —O—, and
R₁ to R₁₀ are each independently selected from the group of hydrogen, a C₁-C₄ alkyl group, a C₁-C₄ alkoxy group, and an amine group, with the proviso that at least two of R₁ to R₁₀ include an amine group.

10. The adhesive film claimed as in claim 6, wherein the amine curing resin is at least one selected from the group of 3,3′-diaminobenzidine, 4,4′-diaminodiphenyl methane, 4,4′ or 3,3′-diaminodiphenyl sulfone, 4,4′-diaminobenzophenone, paraphenylene diamine, metaphenylene diamine, metatoluene diamine, 4,4′-diaminodiphenyl ether, 4,4′ or 3,3′-diaminobenzophenone, 1,4′ or 1,3′-bis(4 or 3-aminocumyl)benzene, 1,4′-bis(4 or 3-aminophenoxy)benzene, 2,2′-bis[4-(4 or 3-aminophenoxy)phenyl]propane, bis[4-(4 or 3-aminophenoxy)phenyl]sulfone, 2,2′-bis[4-(4 or 3-aminophenoxy)phenyl]hexafluorosulfone, 2,2′-bis[4-(4 or 3-aminophenoxy)phenyl]hexafluoropropane, 4,4′-diamino-3,3′,5,5′-tetrabutyldiphenylketone, 4,4′-diamino-3,3′,5,5′-tetraethyldiphenylketone, 4,4′-diamino-3,3′,5,5′-tetra-n-propylenediphenylketone, 4,4′-diamino-3,3′,5,5′-tetraisopropyldiphenylketone, 4,4′-diamino-3,3′,5,5′-tetramethyldiphenylketone, 4,4′-diamino-3,3′,5,5′-tetra-n-propyldiphenylmethane, 4,4′-diamino-3,3′5,5-tetramethyldiphenylmethane, 4,4′-diamino-3,3′5,5′-tetraisopropyldiphenylmethane, 4,4′-diamino-3,3′5,5′-tetraethyldiphenylmethane, 4,4′-diamino-3,3′-dimethyl-5,5′-diethyldiphenylmethane, 4,4′-diamino-3,3′-dimethyl-5,5′-diisopropyldiphenylmethane, 4,4′-diamino-3,3′-diethyl-5,5′-diethyldiphenylmethane, 4,4′-diamino-3,5′-dimethyl-3′,5′-diethyldiphenylmethane, 4,4′-diamino-3,5-dimethyl-3′,5′-diisopropyldiphenylmethane, 4,4′-diamino-3,5-diethyl-3′,5′-dibutyldiphenylmethane, 4,4′-diamino-3,5-diisopropyl-3′,5′-dibutyldiphenylmethane, 4,4′-diamino-3,3′-diisopropyl-5,5′-dibutyldiphenylmethane, 4,4′-diamino-3,3′-dimethyl-5′,5′-dibutyldiphenylmethane, 4,4′-diamino-3,3′-diethyl-5′,5′-dibutyldiphenylmethane, 4,4′-diamino-3,3′-dimethyldiphenylmethane, 4,4′-diamino-3,3′-diethyldiphenylmethane, 4,4′-diamino-3,3′-di-n-propyldiphenylmethane, 4,4′-diamino-3,3′-diisopropyldiphenylmethane, 4,4′-diamino-3,3′-dibutyldiphenylmethane, 4,4′-diamino-3,3′,5-trimethyldiphenylmethane, 4,4′-diamino-3,3′,5-triethyldiphenylmethane, 4,4′-diamino-3,3′,5-tri-n-propyldiphenylmethane, 4,4′-diamino-3,3′,5-triisopropyldiphenylmethane, 4,4′-diamino-3,3′,5-tributyldiphenylmethane, 4,4′-diamino-3-methyl-3′-ethyldiphenylmethane, 4,4′-diamino-3-methyl-3′-isopropyldiphenylmethane, 4,4′-diamino-3-methyl-3′-butyldiphenylmethane, 4,4′-diamino-3-isopropyl-3′-butyldiphenylmethane, 2,2-bis(4-amino-3,5-dimethylphenyl)propane, 2,2-bis(4-amino-3,5-diethylphenyl)propane, 2,2-bis(4-amino-3,5-di-n-propylphenyl)propane, 2,2-bis(4-amino-3,5-diisopropylphenyl)propane, 2,2-bis(4-amino-3,5-dibutylphenyl)propane, 4,4′-diamino-3,3′,5,5′-tetramethyldiphenylbenzanilide, 4,4′-diamino-3,3′,5,5′-tetraethyldiphenylbenzanilide, 4,4′-diamino-3,3′,5,5′-tetra-n-propyldiphenylbenzanilide, 4,4′-diamino-3,3′,5,5′-tetraisopropyldiphenylbenzanilide, 4,4′-diamino-3,3′,5,5′-tetrabutyldiphenylbenzanilide, 4,4′-diamino-3,3′,5,5′-tetramethyldiphenylsulfone, 4,4′-diamino-3,3′,5,5′-tetraethyldiphenylsulfone, 4,4′-diamino-3,3′,5,5′-tetra-n-propyldiphenylsulfone, 4,4′-diamino-3,3′,5,5′-tetraisopropyldiphenylsulfone, 4,4′-diamino-3,3′,5,5′-tetramethyldiphenylether, 4,4′-diamino-3,3′,5,5′-tetraethyldiphenylether, 4,4′-diamino-3,3′,5,5′-tetra-n-propyldiphenylether, 4,4′-diamino-3,3′,5,5′-tetraisopropyldiphenylether, 4,4′-diamino-3,3′,5,5′-tetrabutyldiphenylether, 3,3′-diaminobenzophenone, 3,4-diaminobenzophenone, 3,3′-diaminodiphenylether, 3,3′-diaminodiphenylmethane, 3,4′-diaminodiphenylmethane, 2,2′-diamino-1,2-diphenylethane or 4,4′-diamino-1,2-diphenylethane, 2,4-diaminodiphenylamine, 4,4′-diaminooctafluorobiphenyl, o-dianisidine, 1,5-diaminonaphthalene, 1,8-diaminonaphthalene, 2,3-diaminonaphthalene, pararosaniline, 1,2-diaminoanthraquinone, 1,4-diaminoanthraquinone, 1,5-diaminoanthraquinone, 2,6-diaminoanthraquinone, 1,4-diamino-2,3-dichloroanthraquinone, 1,4-diamino-2,3-dicyano-9,10-anthraquinone, 1,4-diamino-4,8-dihydroxy-9,10-anthraquinone, 3,7-diamino-2,8-dimethyldibenzothiphenesulfone, 2,7-diaminofluorene, and 3,6-diaminocarbazole.

11. The adhesive film claimed as in claim 6, wherein the phenolic curing resin is represented by Formula 6: 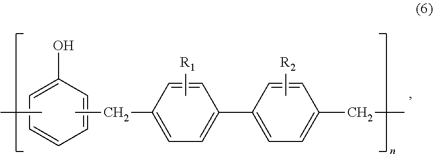
wherein R₁ and R₂ are each independently a C₁-C₆ alkyl group and n ranges from 2 to 100.

12. The adhesive film claimed as in claim 6, wherein the phenolic curing resin is at least one selected from the group of a bisphenol resin, a phenol novolac resin, a bisphenol A novolac resin, a xylene resin, a cresol novolac resin, and a phenolic biphenyl-containing resin.

13. The adhesive film claimed as in claim 6, wherein the curing accelerator includes at least one selected from the group of an imidazole curing accelerator and a microcapsule type latent curing agent.

14. An adhesive composition comprising, based on 100 parts by weight of the adhesive film composition in terms of solid content:
about 51 to about 80 parts by weight of a thermoplastic resin;
about 5 to about 20 parts by weight of an epoxy resin;
about 2 to about 10 parts by weight of a phenolic curing resin;
about 2 to about 10 parts by weight of an amine curing resin; and
about 0.1 to about 10 parts by weight of a curing accelerator.

15. The adhesive composition claimed as in claim 12, wherein the curing accelerator includes one or more selected from the group of an imidazole curing accelerator and a microcapsule type latent curing agent.

16. A electronic device including the adhesive film as claimed in claim 1.

17. A electronic device including an adhesive film formed from the adhesive composition as claimed in claim 6.

18. A electronic device including an adhesive film formed from the adhesive composition as claimed in claim 12.
